(19) United States
(12) Patent Application Publication
(10) Pub. No.: US 2001/0046815 A1
(43) Pub. Date: Nov. 29, 2001

(54) Method of providing electrical energy to devices without using prongs

(76) Inventor: Lionel V. Luu, Anaheim, CA (US)

Correspondence Address: OSTROLENK FABER GERB & SOFFEN, 1180 AVENUE OF THE AMERICAS, NEW YORK, NY, 100368403

(21) Appl. No.: 09/784,013

(22) Filed: Feb. 16, 2001

Related U.S. Application Data
(60) Provisional application No. 60/182,925, filed on Feb. 16, 2000.

(51) Int. Cl. H01R 13/10; H01R 33/00

(52) U.S. Cl. 439/682

(57) ABSTRACT

Methods and apparatus for providing electrical energy to an electrical circuit without using a pronged plug are disclosed. A power connector includes a substrate with openings for receiving prongs of an electrical plug. Contacts supported on the substrate extend into the openings. The contacts are connected to the electrical circuit. The substrate is placed over an electrical outlet receptacle. When the prongs of the electrical plug are inserted through the two openings of the power connector and into the outlet receptacle, the prongs touch each of the contacts, respectively, such that electrical power can be supplied to the electrical circuit connected to the pair of contacts. The power connector can be incorporated into a wall plate mounted over an electrical outlet, either in place of or directly over an existing wall plate. An electrical circuit is housed within the wall plate. Typical electrical circuit devices powered by the present invention include night lights, emergency lights, air fresheners, air purifiers, pest controls, alarms, smoke detectors, carbon monoxide detectors, amplifiers, antennae, motion sensors, home security modules, home automation modules, surge protectors, electronic filters, load indicators, and home-wiring based network connections for telephones or local area networks (LANS).

This application claims the benefit of U.S. Provisional Application Ser. No. 60/182,925 filed Feb. 16, 2000, the entire contents of which are incorporated herein by reference.

### BACKGROUND OF THE INVENTION

1. Field of the Invention

The present invention relates to providing electrical energy to devices. More specifically, the invention relates to a power connection for providing energy to electrical devices without the need for an electrical plug having prongs.

2. Brief Description of the Prior Art

Electrical devices typically require a plug with a set of prongs in order to connect the device to the electrical outlet receptacle. It would be useful to provide a power connection for supplying electrical energy from the outlet receptacle to an electrical device without requiring a plug with a set of prongs.

Night lights have been incorporated into wall plates that surround electrical outlets and switches. See U.S. Pat. Nos. 5,670,776 to Rothbaum, 5,816,682 to Marischen, and 5,660,459 to Appelberg, for example. Some prior art lighted wall plates are installed with a direct electrical connection to the existing wiring system. On other devices, either a battery or a photoluminescent material is utilized, both of which have limited lives and limited capabilities.

It would be desirable to provide electrical devices with a means for obtaining power from an electrical outlet without the need for a plug with prongs. In addition, it would be desirable to provide an easily installed wall plate providing an adjunct electrical device on the wall plate, where the wall plate device did not require direct wiring, and was not limited to devices that were battery driven or had only photoluminescent capabilities.

### SUMMARY OF THE INVENTION

The present invention overcomes the deficiencies of the prior art, such as those noted above, by providing electrical energy to an electrical circuit using a power connection device without using a separate pronged electrical plug for the circuit.

According to a preferred embodiment, the device includes a substrate having two openings for receiving prongs of an electrical plug. A pair of contacts supported on the substrate extends into each of the two openings. The contacts are connected electrically to the electrical circuit. The substrate can be placed over an electrical outlet receptacle. When the two prongs of the electrical plug are inserted through the two openings of the substrate, the prongs make contact with each of the pair of contacts, respectively. Inserting the prongs completely into the outlet receptacle thus provides electrical power to the electrical circuit connected to the pair of contacts. Power also is supplied to a device connected to the electrical plug. The power connector of the present invention can be installed or mounted anywhere between a plug and an electrical outlet. The connector can be adapted for use on an outlet from a power strip, in the back of an audio amplifier, an outlet of a UPS, an extension cord, etc.

In an alternative embodiment, a wall plate is provided for mounting over an electrical outlet. The wall plate has two openings for the prongs of the electrical plug that align with the openings in a wall outlet receptacle. The wall plate can be mounted over the electrical outlet, either in place of or directly over an existing wall plate. The wall plate of the present invention can be screwed or snapped into place, for example. A pair of contacts is supported on the wall plate and extends into each of the two openings, respectively. Again, when the two prongs of the electrical plug are inserted through the two openings and into the outlet, the sides of the prongs touch each of the contacts, respectively, such that electrical power can be supplied to the circuit or device connected to the contacts. An electrical or electronic circuit device preferably is housed within the wall plate as well, and is powered by the power connection built into the wall plate as described above.

Typical electrical circuit devices that can be powered by the present invention include, without limitation, night lights, emergency lights, air fresheners, air purifiers, pest controls, alarms, smoke detectors, carbon monoxide detectors, amplifiers, antennae, motion sensors, home security modules, home automation modules, surge protectors, electronic filters, load indicators, and home-wiring based network connections for telephones or local area networks (LANS). Some of the various applications can utilize a rechargeable battery, as will be apparent to those of skill in the art. Other devices can utilize microprocessors or other active devices powered through the connection, the microprocessor-based devices providing control and diagnostic capabilities, for example, to the application.

The contacts touched by the plug prongs typically are made of thin flexible metal, such as copper, or other electrically conductive material. Materials having significant resilience are preferred, or the contact could be mounted with in a known manner to have spring-loaded resilience. The contacts preferably are designed to touch the broad sides of the prongs that will be plugged into the outlet receptacle.

According to a preferred embodiment, thin copper contacts are housed between two thin plastic pieces for secureness. Preferable thermoplastic materials include ABS and PBT. In applications that require a high electrical index rating for good insulation material as required by Underwriters Laboratory, for example, contacts can be housed within PBT, a relatively expensive material. Components that use PBT and other expensive materials preferably are provided in a modular form to minimize costs. The remainder of the wall plate can be made from standard electrical plastic such as ABS. Advantageously, the modular approach also provides a rapid and flexible way to develop new product lines. The module containing the contacts can be mounted on other devices or other wall plate housings designed to provide new product offerings. This approach can speed up the UL safety standard investigation cycle as new products are being developed by eliminating, for example, mechanical tests related to the contact components.

Other features and advantages of the present invention will become apparent from the following description of the invention which refers to the accompanying drawings.

### BRIEF DESCRIPTION OF THE DRAWINGS

FIG. 1 is a schematic plan view of the front of a wall plate cover with an electroluminescent night light according to the present invention.

FIG. 2 is a schematic plan view of the rear of a wall plate cover according to the present invention.

FIG. 3 is a perspective illustration of a flat panel night light according to the present invention.

FIG. 4 illustrates the night light of FIG. 3 placed against an electrical outlet into which an electrical plug is inserted, illuminating the light according to the present invention.

FIG. 5 is a perspective view illustrating a wall plate with a switched incandescent night light according to the present invention.

FIG. 6 is a perspective view of a wall plate with a surrounding flat panel night light according to the present invention.

FIG. 7 is a perspective view of a combined flat panel night light and air freshener according to the present invention.

FIG. 8 is a perspective illustration of an emergency light according to the present invention.

FIG. 9 is a perspective illustration of a critical application wall plate according to the present invention.

FIG. 10 is a perspective view of a load detection wall plate according to the present invention.

FIG. 11 is a perspective illustration of a detector wall plate according to the present invention.

FIG. 12 is a surge protector according to the present invention.

FIG. 13 is a combination toggle switch and duplex outlet wall cover according to the present invention.

FIG. 14 is a perspective view of an antenna and amplifier coupling according to the present invention.

### DETAILED DESCRIPTION OF EMBODIMENTS OF THE INVENTION

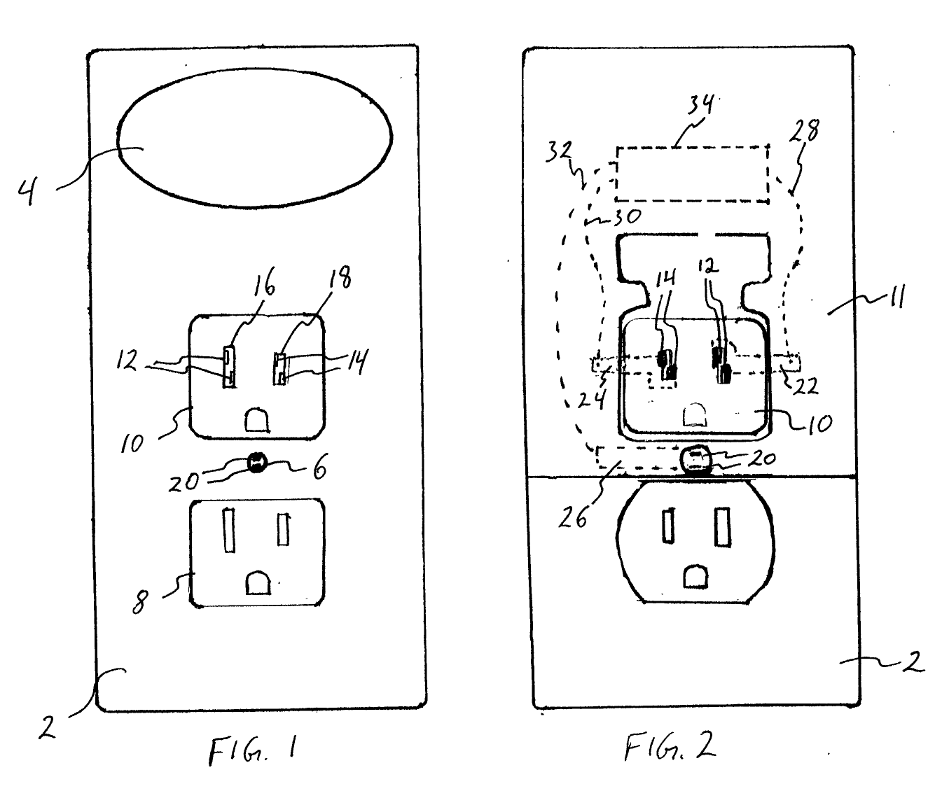

Referring initially to FIG. 1, a wall plate cover 2 according to the present invention is shown schematically in plan view. An flat panel night light 4 is mounted on the wall plate cover. The flat panel light is made from an electroluminescent material. The wall plate cover mounts over an existing duplex wall plate. Alternatively, the wall plate cover can be used to replace the existing wall plate. The wall plate cover 2 is secured in place using a wall plate screw inserted through hole 6.

Provided on the wall plate cover 2 are two receptacle covers 8 and 10. As shown in FIG. 1, lower receptacle cover 8 is simply a blank cutout in the wall plate cover 2. Upper receptacle cover 10 is provided with contacts 12 and 14 mounted on either side of the prong openings 16 and 18. The contacts 12, 14 are connected electrically to the light 4. As explained further below, when the prongs of an electrical plug are inserted through the prong openings 16 and 18, the prongs touch contacts 12 and 14, thereby supplying electrical power to light 4. A pair of ground contacts 20 also is provided adjacent screw hole 6 to provide grounding for the wall plate device.

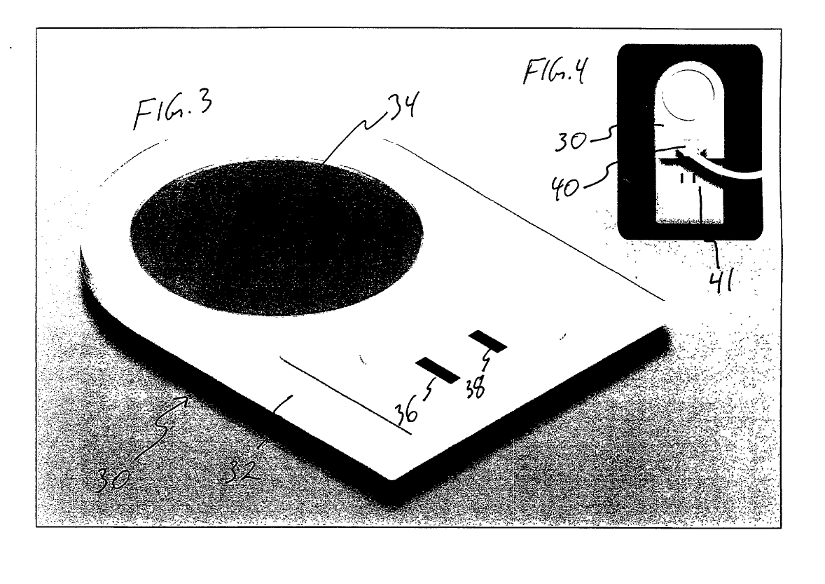

Referring to FIG. 2, a rear of wall plate cover 2 according to the present invention is shown. Behind a rear cover 11, contacts 12 and 14 are provided as extensions of connecting strips 22, 24 respectively. Similarly, ground contacts 20 are extensions of connecting strip 26. The strips are formed by stamping from flat copper blanks. These strips are connected by wires 28, 30, and 32 to circuit 34 for powering the electroluminescent lamp 4, for example, or for powering or controlling other devices as set forth below. A similar arrangement could be provided on lower receptacle cover 8, as well, for powering the same or additional devices.

Referring further to FIGS. 1 and 2, receptacle cover 10 with contacts 12 and 14 and connecting strips 22 and 24 preferably are formed as a separate module that can snap into place on wall place cover 2. Advantageously, the thin copper strips are embedded or sandwiched in the plastic of cover 10. Accordingly, the plastic to be used for cover 10 provides insulated protection for the connecting strips. The receptacle cover 10 is provided as a separate module that can be made of a plastic having higher insulative properties than the plastic used to form the rest of wall plate cover 2. Forming the receptacle cover 10 out of a plastic such as polybutylene terephtalate (PBT), for example, instead of ABS can achieve higher safety standards required for various applications. Thus, even though PBT is considerably more expensive than ABS, only a small proportion of the wall cover will be made of the expensive plastic, keeping costs low.

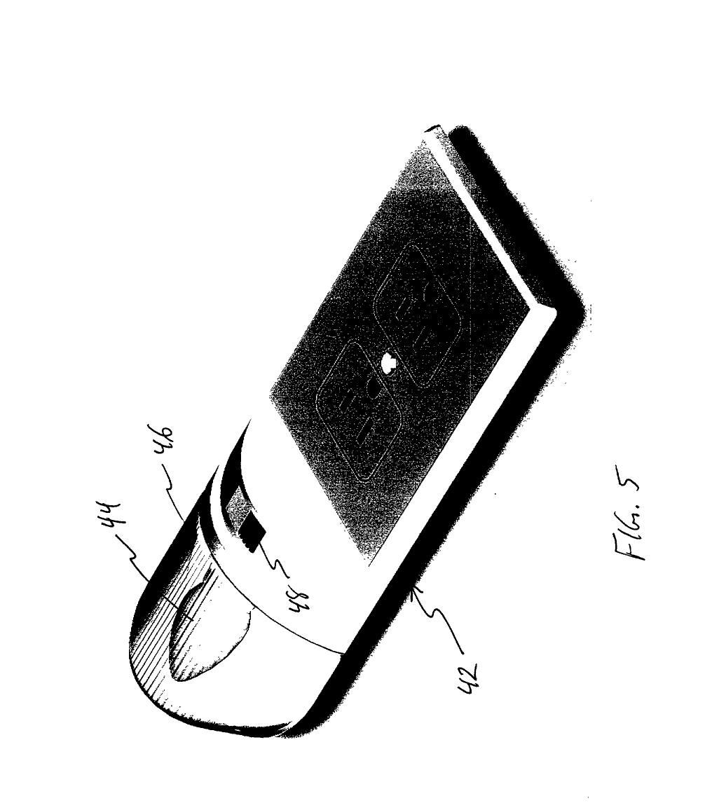

Referring to FIGS. 3-15, various alternative embodiments of the present invention will be described. In each of the alternatives described, electrical power is supplied to the device as needed by way of an electrical plug inserted through openings to be provided adjacent an underlying outlet receptacle. Electrical power is transmitted by prongs on the plug to the device by way of contacts disposed within the openings that contact the plug prongs, as described above in connection with FIGS. 1 and 2.

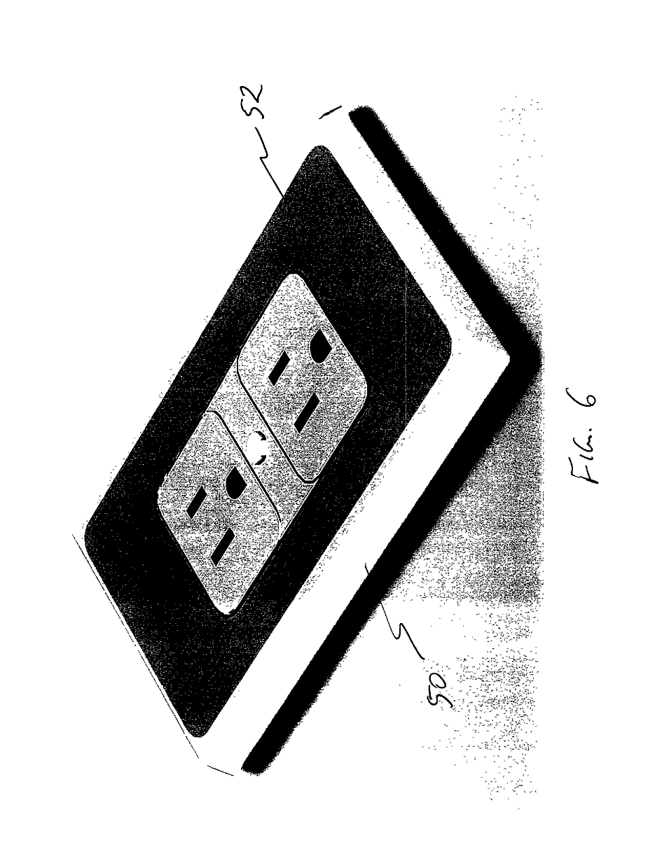

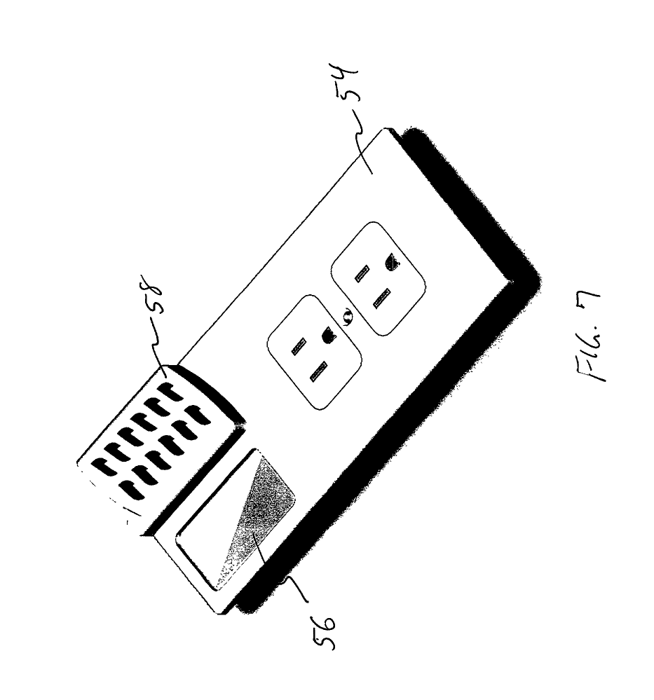

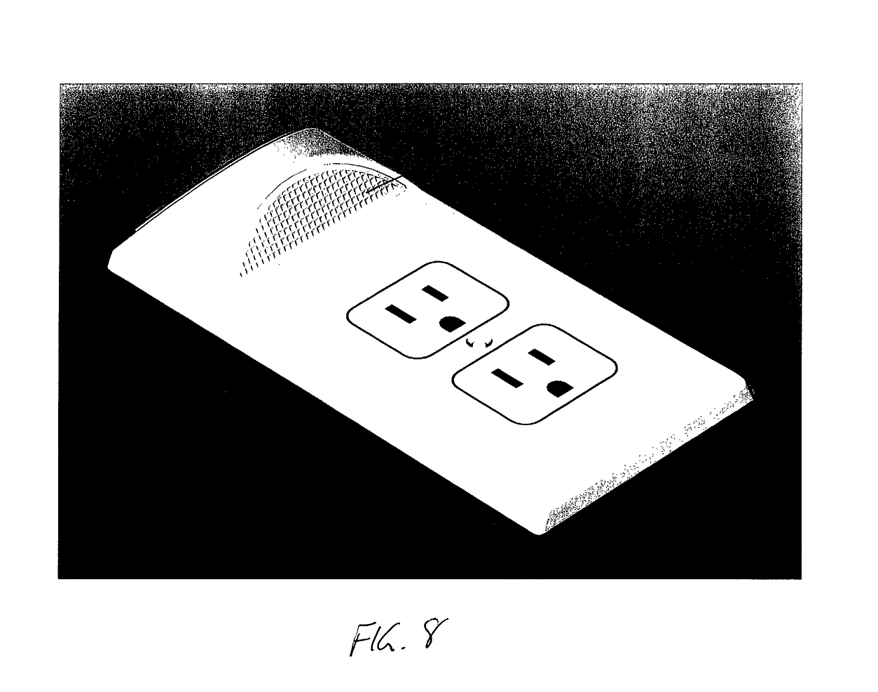

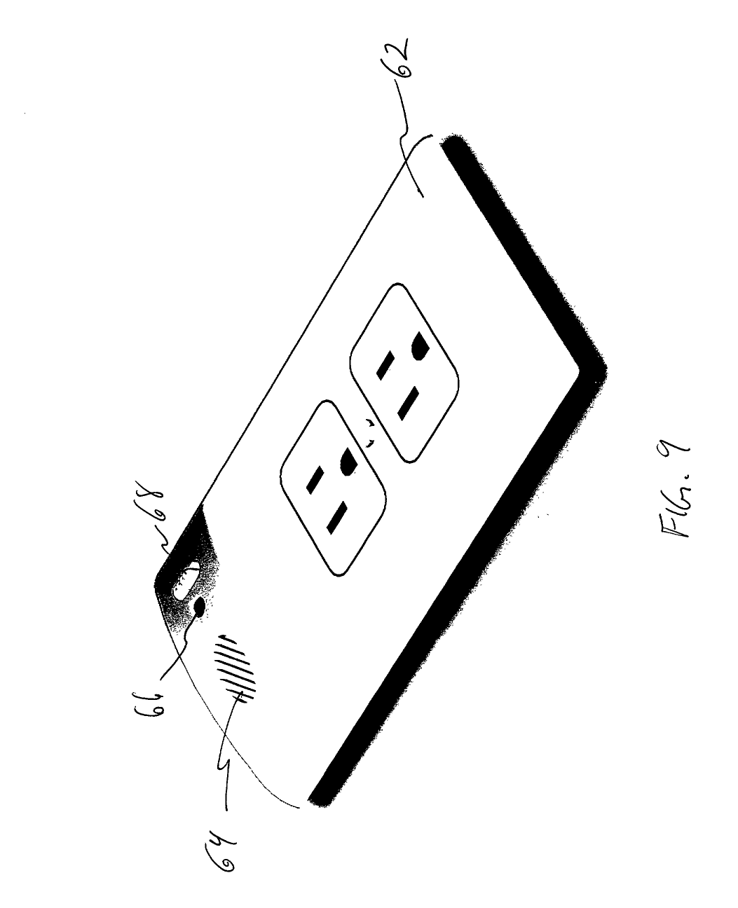

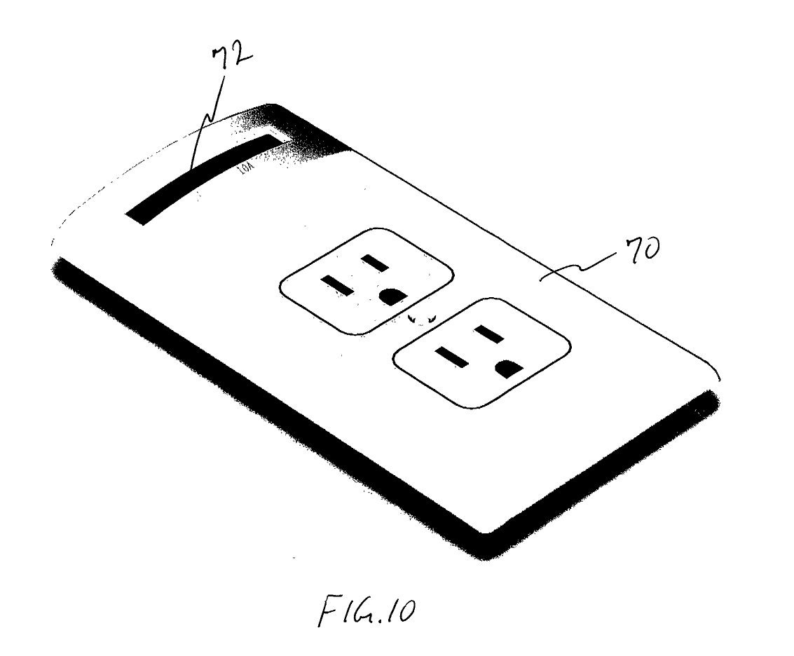

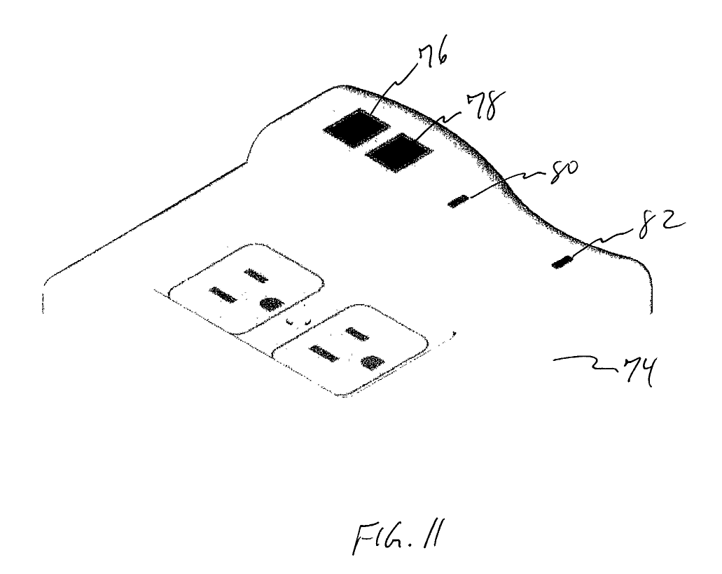

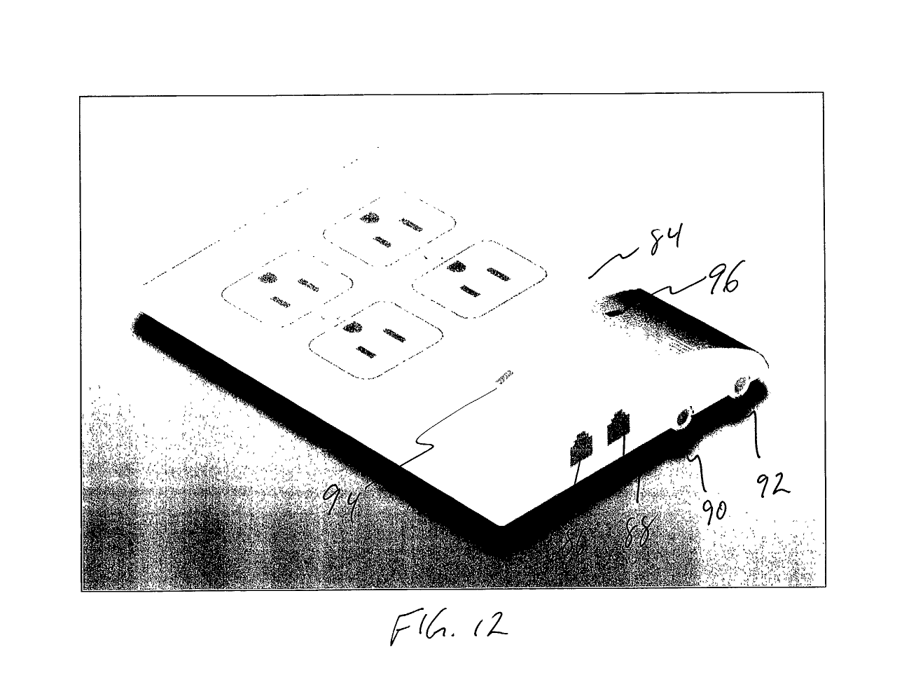

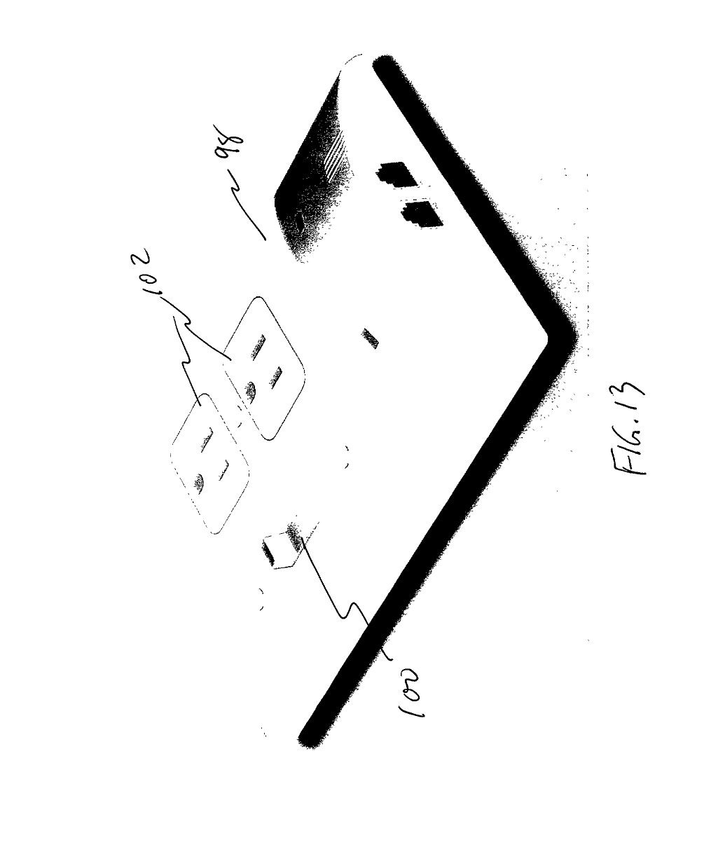

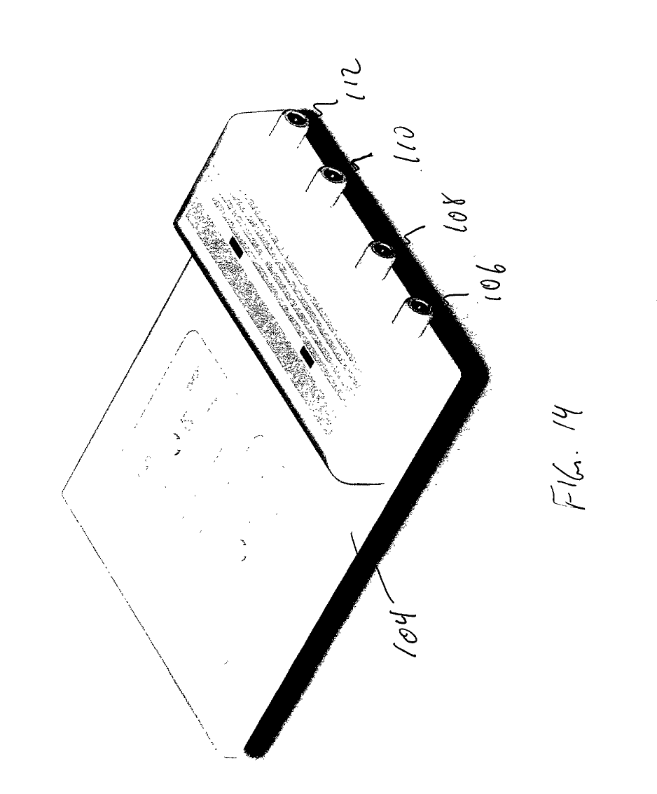

FIG. 3 illustrates a flat panel night light 30 according to the present invention. The nightlight housing 32 made of injection molded thermoplastic contains an electroluminescent (EL) lamp 34. The lamp is powered by inserting the prongs of an electrical plug into plug openings 36, 38. Copper contact strips (not shown) positioned with the openings touch the prongs to provide power to the lamp. The contact strips are provided in a manner similar to that described above in connection with FIGS. 1 and 2. FIG. 4 shows the night light 30 held in position at an electrical outlet by an electrical plug 40. The prongs of the plug 40 have been inserted through openings 36, 38 in the housing and into an upper receptacle of the electrical wall outlet 41, thus providing power to illuminate the lamp. The prongs of the electrical plug hold the lighted night light in position against the wall outlet.

In FIG. 5, a more conventional night light is shown disposed on a wall plate cover similar to that described above in connection with FIGS. 1 and 2. The night light wall plate assembly 42 includes an incandescent bulb 44 enclosed within a clear plastic casing 46. The night light can be operated by a slide switch 48. Electrical power is provided to bulb 44 by way of electrical contact strips (not shown) similar to contacts 12 and 14 of FIGS. 1 and 2.

FIG. 6 illustrates an alternative type of flat panel night light incorporated into a wall plate cover 50. An EL material 52 surrounds the outlet receptacles on the wall plate cover. As before, the EL material receives power by way of the prongs of an electrical plug which make a connection with contacts disposed within the openings on the wall plate, as described above.

FIG. 7 illustrates a combined night light and air freshener wall plate cover 54. An EL material 56 and a heated air freshener module 58 receive power from contacts in the plug receptacle openings, as described. Instead of an air freshener, an active air purifier could be included, for example.

FIG. 8 illustrates an emergency lighting application of the present invention in which an emergency light fixture 60, including a lamp powered by a rechargeable battery (not shown) is provided. The lamp would light, powered by the battery, upon loss of power to the outlet. The rechargeable battery receives charging power by way of an electrical plug inserted through the openings in the wall plate cover and into the underlying outlet receptacle by way of contacts disposed on the wall plate cover as described above. Alternatively, the light shown in FIG. 8 is provided as a separate light module connected to the wall plate by wires, for example.

FIG. 9 illustrates a critical application wall plate cover 62. The wall plate includes an alarm that is activated upon removal of an electrical plug from the outlet. The alarm sound emanates from a grill opening 64 formed in a wall plate housing. A status light 66 indicates proper function of the device. The alarm can be controlled by a slide switch 68.

FIG. 10 illustrates a load detection wall plate cover 70. The wall plate houses a load meter 72 which indicates the amperage being drawn from the outlet. Alternatively, or in addition, a status lamp or alarm could be provided to indicate an overload condition.

FIG. 11 illustrates a generalized detector wall plate cover 74 according to the present invention. The housing provides access 76, 78 to various detector sensors. Status lights 80, 82 indicate function. A variety of detectors could be provided within the housing, including smoke detectors, carbon monoxide detectors, and motion sensors, among others.

FIG. 12 illustrates a surge protector wall plate cover 84 according to the present invention. Circuitry for surge protection and filtering, well known in the art, is contained within the wall plate housing and is powered by plug prongs by way of contacts in the receptacle openings as described above. Various plug receptacles 86, 88 are provided for attachment of telephone or network devices. Other types of cables, such as for computer networks or antennae, can be connected by way of connectors 90, 92. Indicator lights 94, 96 provide status information. Audible alarms also could be included in the device.

FIG. 13 illustrates a combination toggle switch/duplex outlet wall plate cover 98 according to the present invention. The cover plate is installed surrounding an existing toggle switch 100 and duplex outlet 102. Within the housing, surge protection circuitry for a telephone, for example, is provided. Electrical power for the surge protection circuit could be provided by way of the plug prongs of the electrical plug attached to the telephone itself and plugged into one of the duplex outlet receptacles.

FIG. 14 illustrates an antennae/amplifier wall plate cover 104 according to the present invention. Cable attachments 106, 108, 110, 112 provide access to a power antenna and/or a signal amplifier housed within the wall plate cover and powered by accessing the outlet receptacles by way of plug prongs as described above in connection with FIGS. 1 and 2.

Other devices that could be powered by way of the present invention include pest controls, home automation modules, and home security modules, among others. Each of the devices described above and incorporated into a wall plate module could also be provided as a separate unit receiving power from the wall plate module. Alternatively, the devices could be attached to a power connector in the from of a simple outlet receptacle overlay such as a disk of thermoplastic having contacts mounted as described above and connected by wires to the electrical device. The wall plates or overlays could be attached permanently, using screws for example. Alternatively, the wall plates or overlays could be snapped into place, or simply held in place, for example, by the friction of an electrical plug inserted through their openings.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of providing electrical energy to an electrical circuit, the method comprising the steps of:
providing a pair of electrical contacts for the circuit adjacent an electrical outlet receptacle; and
inserting an electrical plug having at least two prongs into the outlet receptacle, each of the two prongs contacting each of the pair of contacts, respectively,
whereby electrical power is provided from the electrical receptacle to the electrical circuit connected to the pair of contacts.

2. A power connector for an electrical circuit comprising:
a substrate having two openings for prongs of an electrical plug, the substrate being configured for placement adjacent an electrical outlet receptacle; and
a pair of contacts supported on the substrate and extending into each of the two openings, respectively, for connection to the electrical circuit;
whereby the two prongs of the electrical plug inserted through the two openings and into the outlet receptacle make contact with each of the pair of contacts, respectively, such that electrical power can be supplied to the electrical circuit connected to the pair of contacts.

3. A wall plate comprising:
a substrate having two openings for receiving prongs of an electrical plug and mountable over an electrical outlet; and
a pair of contacts supported on the substrate and extending into each of the two openings, respectively, for connection to the electrical circuit;
whereby the two prongs of the electrical plug inserted through the two openings and into the outlet contact each of the pair of contacts, respectively, such that electrical power can be supplied to the electrical circuit connected to the pair of contacts.

4. The wall plate of claim 3, further comprising an electrical circuit mounted on the wall plate.

5. The wall plate of claim 4, wherein the electrical circuit includes at least one of a night light, an emergency light, an air freshener, an air purifier, a pest control, an alarm, a smoke detector, a carbon monoxide detector, an amplifier, an antenna, a motion sensor, a home security module, a home automation module, a surge protector, an electronic filter, a load indicator, and a home-wiring based network connection for a telephone or local area network.
